(19) United States
(12) Patent Application Publication
(10) Pub. No.: US 2009/0233206 A1
(43) Pub. Date: Sep. 17, 2009

(54) Toner having excellent image uniformity

(76) Inventors: Hyeung-Jin Lee, Daejeon (KR); Chang-Soon Lee, Daejeon (KR); Jong-Eun Kim, Daejeon (KR)

Correspondence Address: MCKENNA LONG & ALDRIDGE LLP, 1900 K STREET, NW, WASHINGTON, DC, 20006, US

(21) Appl. No.: 12/227,599

(22) PCT Filed: Dec. 6, 2007
(86) PCT No.: PCT/KR2007/006323

§ 371 Date: Nov. 21, 2008

(30) Foreign Application Priority Data
Dec. 6, 2006 (KR) 10-2006-0123355

(51) Int. Cl. G03G 9/093; G03G 9/08

(52) U.S. Cl. 430/108.11; 430/108.6; 430/108.4

(57) ABSTRACT

There is provided a toner having narrow charge distribution, high chargeability and low image contamination, as well as excellent physical properties such as long-term stability, transfer property and image uniformity, by improving shapes of toner core particles and adding a suitable external additive to surfaces of the toner core particles. The toner includes spheroidized toner core particles; and an external additive coated onto surfaces of the toner core particles, wherein the external additive comprises organic powder, silica and spherical titanium dioxide powder. The toner may be useful to obtain a highly uniform and high-quality image even when the toner of the present invention is used for an extended time since the toner has high chargeability, excellent image uniformity in which charge uniformity and narrow charge distribution are maintained for a long time, low image contamination, as well as excellent physical properties such as transfer property and long-term stability.

### TECHNICAL FIELD

The present invention relates to a toner having excellent image uniformity, and more particularly, to a toner having narrow charge distribution, high chargeability and low image contamination, as well as excellent physical properties such as long-term stability, transfer property and image uniformity, by improving shapes of toner core particles and adding a suitable external additive to surfaces of the toner core particles.

### BACKGROUND ART

Recently, there have been increasing demands for a copying machine and a laser printer along with the wide distribution of Personal Computers (PCs) and the office automation. Both the copying machine and the laser printer are image forming apparatuses that display a desired image by transferring a toner on a printing paper, and thus essentially uses toner to form an image.

Along with the increasing demand for the copying machine, the laser printer and the like in the market, consumer requirements for the copying machine, the laser printer and the like gradually become stricter. Examples of such requirements include clearer image quality, durability ensuring that toner will show no deterioration in charging characteristics even if it is used for a long time period, the miniaturization of the copying machine or the printer, low price, high printing speed, energy saving, easy recyclability and the like.

Among the above requirements, the durability is required for toner itself. That is, durability ensures that a clear image can be continuously maintained and charging characteristics of the toner are not degraded when the toner is used for an extended time. There have been many attempts to produce durable toner in the fields of producing toner.

Toner is a developer material that is used for printers or copying machines to form an image on an image receptor in a transfer operation. In order to produce durable toner that can continue to maintain a clear image, processes of using toner in the copying machine or the laser printer should be understood first of all.

An image forming apparatus, such as a copying machine or a laser printer, which produces printouts by transferring toner, generally carries out a printing process as follows:

1. First, a charging step of uniformly charging a surface of a drum is performed. An Organic Photo Conductor (OPC) drum and the like are generally used as the drum. The charging is conducted by electrostatically charging the drum surface using a charging rayon brush and the like.

2. Then, an exposure step of forming an electrostatic latent image by exposing the drum surface is followed. A charged body such as an organic photo conductor (OPC) on the unifromely charged drum surface functions as an insulator when light is not incident on the drum surface, but functions as a conductor for conducting charges in the presence of light. Thus, when the drum surface is exposed to the light such as laser beams, only the light-exposed portion is discharged or neutralized.

3. Apart from the exposure step, a step of attaching a toner to a surface of a developer roller is carried out. This is a preliminary step, followed by a step of forming a toner image on the charged drum.

4. Subsequently, performed is a development step of developing the latent image on the surface of the drum with the toner attracted to a surface of the previously prepared developer roller, thereby forming an image. As described above, when the drum surface is exposed to light, the exposed portion thereof is discharged or neutralized. This is why, when the toner is charged with the same polarity as that of the drum surface, the no-exposed portion of the drum surface will repel toner to prevent toner from being transferred onto the latent image. However, the toner may adhere to the latent image in a desired image shape since the exposed portion of the drum surface does not repel toner.

5. After the development step, a step of transferring the toner image from the drum surface to an image-receiving paper (i.e., a printing paper) is performed. In the transfer step, a surface of the image-receiving paper is charged with a polarity opposite to that of the toner to generate an attraction force between the toner and the image-receiving paper, and the drum and the image-receiving paper are placed adjacent to each other in order to facilitate the transferring operation.

6. Since the toner is not permanently bonded to the image-receiving paper even though it is transferred to the image-receiving paper, a fusion step of fusing the toner to the image-receiving paper is followed. The fusion step is generally carried out by pressing the toner with heat and pressure while allowing the image-receiving paper, on which the toner image is formed, to pass between a pair of rollers including a heat roller and a pressure roller, and forming a coating layer around the toner using a binder in the toner.

7. Finally, prior to the recharging of the drum, a step of cleaning residual toner from the surface of the drum is carried out to charge the drum again for the next process cycle.

In consideration of the above-mentioned printing process, basic characteristics of toner required for respective steps of the printing process can be understood.

First of all, toner should necessarily have at least a predetermined level of chargeability so as to attach toner to a developer roller, to develops the toner on the OPC drum and to transfer the toner to the image-receiving paper. That is, since toner is charged by friction against a doctor blade in the process of attaching toner to a developer roller in a toner hopper of a toner cartridge, it is required that toner have a suitable level of chargeability, so that the subsequent steps, such as migration from the developer roller to the charged drum and transferring from the charged roller to the image-receiving paper, can be easily carried out.

And, the chargeability of the toner particles is desirable to maintain charge distribution to a narrow extent, that is, the toner preferably has chargeability that is as uniform as possible. When the charge distribution is wide, the incompletely charged particles or excessively charged particles are present in the toner, and therefore background contamination or edge contamination appears, which makes it difficult to obtain a desired image.

It is also required that toner, after being charged, continuously maintain the charge state until the toner is transferred to an image-receiving paper. This is referred to as charge-maintaining ability that can prevent the charge from being lost through the contact with conductive materials or other toners.

Specific forms of the above-mentioned charge-maintaining ability include environmental safety. That is, the charge state of the toner may be at a loss when toner particles are kept under moisture-rich environments since the moisture may serve as the above-mentioned conductive material. Accordingly, toner having high environmental safety may be prepared by preventing moisture from being in contact with a surface of a charge layer of the toner.

To facilitate the transfer of toner to the image-receiving paper in a subsequent transfer process, the toner also requires excellent physical properties such as transfer property, low temperature fusion ability and anti-offset property. With the excellent transfer property, toner can be easily released from a photoconductive drum and attached to an image-receiving paper. The low temperature fusion ability allows toner to be easily fused with the image-receiving paper even if it is not heated to a high temperature in the fusion process. The anti-offset property may be excellent against the offsetting of residual toner to a surface of the charged roller.

In addition, other properties such as cleaning performance and anti-contamination property are required in a cleaning process.

In particular, recently, the above-mentioned properties are required complexly and comprehensively owing to the increasing demands for high image quality, high speed and color expression.

Accordingly, in order to satisfy all of the above requirements, a toner generally includes toner core particles including a colorant for realizing colors, a binder resin, a wax, a dispersant, a release agent, a charge control agent and the like; and an external additive attached to an outer surface of the toner core particles.

In order to facilitate the adhesion of the toner to a surface of an image-receiving paper, the binder resin is melted by heating during the fusion of the toner. The wax gives gloss to an image when being printed, and functions to drop the melting point of the toner core particles. The dispersant induces uniform dispersion of the toner, and the charge control agent functions to control the charge on surfaces of the toner core particles.

Of these additives, the charge control agent (abbreviated “CCA”) forming the toner core particles functions to charge surfaces of the toner particles when the toner is in friction with a doctor blade. It is required that the CCA be dispersed on the surfaces of the toner core particles as evenly as possible. That is, the charge control agent present inside the toner core particles is undesirable since it hardly affects the charging of the toner. If the charge control agent is not suitably present in a surface of toner, charging characteristics of the toner are not maintained stably, which leads to the unstable image.

Also, the toner that has been transferred and developed into a charged drum should be then easily transferred to an image-receiving paper. However, when the toner particles are too strongly attached to the charged drum, the toner is not easily transferred to the image-receiving paper, which leads to the deteriorated transfer property.

In particular, this problem may be more serious when a color image is printed in a color printer. As the method for forming a color image, a method of directly developing a toner of four cyan, magenta, yellow and black colors into a photoconductive drum, mixing the four colors and directly transferring the color mixture to an image-receiving paper, an indirect transfer method using an intermediate transfer body to reproduce colors more elaborately are used. A method using an indirect transfer device refers to a method of transferring a toner image of a drum surface to an intermediate transfer body so that colors are overlapped with each other, and transferring the toner image from the intermediate transfer body to an image receiving body. This method has been widely used for full-color printers owing to the increased possibility of realizing high speed and high definition.

Furthermore, a tandem type development system, which is suitable for high-speed printing since respective colors are set respectively to drums, has also been widely used in the full color printers along with the recent high-speed printing trends. The tandem type development system is a kind of the indirect transfer method that uses a transfer belt (intermediate transfer body).

However, the indirect transfer image forming apparatus requires higher and more exact transfer performances to give high definition due to the increased numbers in the transfer step. Accordingly, the toner should have stable charging performance for this purpose. Also, the charge control agent should be densely distributed on surfaces of the toner core particles since the toner also has a high transfer property, and an adhesive force to the drum should be as low as possible.

The above adjustment of the adhesive force is required for the cleaning process. Therefore, the adhesive force between the toner and charged drum is preferably low since a relatively small amount of the residual toner may be more easily cleaned and it is necessary to remove the residual toner from the drum as easily as possible.

As the conventional method for reducing an adhesive force between the toner and the photoconductive drum, there has been proposed a method of introducing peelable particulates usch as silica into the toner. The proposed method is to reduce an adhesive force between a toner and a drum by attaching particulates to a surface of the toner to interpose the particulates between the toner and the drum. To improve transfer property of toner according to the method, the coating of the toner surface with the particulates should be maintained to a high coating rate. In order to improve transfer property of toner through the simple control of the adhesive force, the particulates should be added in an increased amount. When the particulates are added in an increased amount, chargeability of toner may be deteriorated and the attachment of the particulates to an electrostatic latent image support, filming fusion defects and the like may appear. In particular, since silica particles are highly environment-dependent, the silica particles have problems that an image may be stained by static electricity under conditions of low temperature and moisture, or a non-image region may be contaminated under conditions of high temperature and moisture. Therefore, stabilities (long-term stability, durability) of toner may be adversely affected when the toner is stored for an extended period.

Accordingly, a method for adding inorganic particulate matter such as titanium dioxide instead of the silica particles to improve environmental dependency of the toner has been known in the art, wherein the inorganic particulate matter has a low electric resistance and good charge exchangeability when compared to the silica particles. However, charge distribution of the toner may be easily changed when the inorganic particulate matter having low electric resistance is used for the toner, and the toner may be poorly transferred to a secondary image-receiving paper, or the reverse-polarity toner may be easily retransferred in the multiple transfer of the full color toner when the intermediate transfer body is used for the toner. Therefore, to simply add silica, titanium dioxide or the like is not a solution to the problem that an adhesive force is reduced by adjusting a charge amount of toner to a suitable range.

To solve the above problems, there is a method for surface-trating an inorganic particulate matter, such as titanium, that has low resistance, with a silane coupling agent and the like in order to improve resistance. However, the method has problems that particulates are poorly distributed due to the strong cohesion of the particulates, and fluidity of toner may be degraded or the toner may be blocked by free agglomerated particles when the toner has a poor function to enhance its own charge exchangeability.

Also, the toner particles are generally produced by a pulverization process of melting the above-mentioned components, forming a sheet material from the melt, and mechanically pulverizing the sheet material, or by a polymerizing process. The mechanical pulverization process has been widely used up to now since it is relatively easier to produce toner. However, in the case of producing the toner particles by the mechanical pulverization, a large number of cracks exist in the surface of the toner core particles. As a result, when friction and stress are applied to the cracked toner core particles so as to give charging characteristics to the toner core particles, the stress converges on cracked regions of the toner core particles, and thus the toner core particles may be more finely ground.

Furthermore, the toner core particles produced by the mechanical pulverization method are not more spherical in shape than the toner core particles produced by the polymerization method. The toner core particles need to escape from the toner hopper while undergoing a suitable range of a frictional force when the toner core particles are attached to a developer roller in the toner hopper and contacted with a doctor blade. However, the toner core particles may be subject to excessive pressure from the doctor blade when the toner particles have irregular shapes other than the spherical shape. As a result, the toner core particles are attached or agglomerated into the doctor blade, or the developer roller may be contaminated owing to the high heat and stress generated by the excessive pressure.

In this case, the toner is not actively charged since subsequently discharged toner core particles are poorly contacted with a doctor blade, which may cause a problem on the image uniformity that an upper portion and a lower portion of an image are not formed uniformly.

### DISCLOSURE OF INVENTION

### Technical Problem

An aspect of the present invention provides a toner having narrow charge distribution characteristics and high chargeability without degrading image uniformity when toner core particles are in contact with a doctor blade even if the toner core particles are produced by the mechanical pulverization method, and also having low image contamination as well as excellent physical properties such as long-term stability, transfer property and image uniformity.

### Technical Solution

According to an aspect of the present invention, there is provided a toner including spheroidized toner core particles; and an external additive coated onto surfaces of the toner core particles, wherein the external additive comprises organic powder, silica and spherical titanium dioxide powder having a spheroidization rate of 0.6 or more, represented by the following Equation 1.

Spheroidization rate=Circumference of a circle when being spherical/Circumference of particles Equation 1

The spheroidized toner core particles may have a spheroidization rate of 0.5 to 0.8 according to the Equation 1.

The spheroidization may be carried out in one process selected from the group consisting of a process of spheroidizing toner particles using interfacial tension of the toner particles by spraying toner particles with thermal air current, and a process of grinding toner particles into a spherical shape by applying mechanical stress and frictional force to the toner particles.

Also, the organic powder may include large particles having an average particle size of 600 to 1000 nm and small particles having an average particle size of 50 to 120 nm.

The organic powder may be selected from the group consisting of polytetrafluoroethylene (PTFE), polymethylmethacrylate (PMMA) and polyvinylidene fluoride (PVDF).

Contents of the small particles and the large particles may range from 0.4 to 1.0 part by weight and from 0.4 to 2.0 parts by weight, respectively, based on 100 parts by weight of the toner core particles.

Also, the spherical titanium dioxide powder may be composed of rutile-phase titanium dioxide.

Furthermore, the spherical titanium dioxide powder may have an average particle size of 300 to 1000 nm.

Also, a content of the spherical titanium dioxide powder may range from 1.5 to 4 parts by weight based on 100 parts by weight of the toner core particles.

And, the silica particles may have a particle size of 5 to 20 nm.

Also, a content of the silica particles may range from 2 to 4 parts by weight, based on 100 parts by weight of the toner core particles.

Furthermore, the toner may have a particle size of 10 μm or less, and preferably a particle size of 3 to 9 μm.

### ADVANTAGEOUS EFFECTS

The toner according to the present invention may be useful to obtain a highly uniform and high-quality image even when the toner of the present invention is used for an extended time since the toner has high chargeability, excellent image uniformity in which charge uniformity and narrow charge distribution are maintained for a long time, low image contamination, as well as excellent physical properties such as transfer property and long-term stability.

### BRIEF DESCRIPTION OF THE DRAWINGS

FIG. 1 is a perspective view illustrating positions in which test sample for measuring image density are taken from a printing paper so as to test image uniformity.

### BEST MODE FOR CARRYING OUT THE INVENTION

Hereinafter, the present invention will be described in detail.

The present inventors have studied to solve the conventional problems that the toner core particles produced by the mechanical pulverization method have, and found that, when the toner core particles produced by the mechanical pulverization method are spheroidized into nearly spherical shapes since the toner core particles have irregular shapes, toner can be prevented from being fixed into a developer roller or a doctor blade by the excessive pressure and beat when the toner is in contact with the doctor blade. Also, electrostatic charges converges on tips of protrusions (particularly, acute protrusions) that are frequently present in surfaces of irregular particles when the irregular particles are charged, which leads to the supercharging phenomenon. Therefore, edge contamination and the like may appear as side effects of the supercharging phenomenon. On the contrary, the spheroidization of the toner core particles is desirable to accomplish the objects of the present invention since the toner core particles that are spheroidized as described above have more uniform charge distribution.

However, it is important to set a spheroidization rate to a suitable extent for toner since it is difficult to produce toner core particles having completely spherical shape through the spheroidization process and the spheroidization cost is high, and difference in effects between the completely spherical shape and the nearly spherical shape is not considerable.

In general, the spheroidization rate of the particles is defined by the following Equation 1.

Spheroidization rate=Circumference of a circle when being spherical/Circumference of particles Equation 1

The spheroidization rate may be calculated by taking a two-dimensional photograph of the particles using a scanning electron microscope (SEM) to calculate the circumference of the two-dimensional shapes of the particles as circumference of particles and defining the circumference of a circle as circumference of a circle when being spherical, the circle having the same two-dimensional area as the particles.

According to the research results by the present inventors, the spheroidization rate of the toner core particles is preferably at least 0.5. When the spheroidization rate is less than 0.5, the toner is fixed into the doctor blade, the developer roller, or the like in the printing process as described above, and therefore image uniformity of the toner is deteriorated significantly. Also, when the spheroidization rate exceeds 0.8, the spheroidized particles may not be easily washed from a surface of the photoconductive drum. Also, if the above problem is not solved, the toner may be continuously fused into a surface of the photoconductive drum due to the friction between a cleaning blade and the surface of the photoconductive drum, thereby to cause image contamination and shorten a life span of the photoconductive drum. Therefore, it is preferred to define the upper limit of the spheroidization rate to 0.8.

The mechanically pulverized toner core particles should be subject to the spheroidization process to control their spheroidization rate to the above spheroidization range. The spheroidization process for producing spherical toner core particles includes a mechanical process and a thermal process. The thermal process generally produces spherical particles using interfacial tension of toner particles by spraying toner particles with thermal air current. The mechanical process includes a method of grinding toner particles into spherical shapes by providing mechanical stress and frictional force to the toner particles. All advantages of the thermal process and the mechanical process may be used in the spheroidization process. However, particles having a large particle size may be easily formed through the agglomeration of the particles when spherical particles are procuded by the thermal process, and particles may be then ground into finer particles in a grinding process when spherical particles are produced by the mechanical process.

As described above, it is possible to prevent the deterioration of image uniformity caused by the toner core particles by controlling a spheroidization rate of the toner core particles, but the toner core particles may be more preferably subject to additional processes to provide a toner that has improved image uniformity, narrow charge distribution and high chargeability, low image contamination and excellent physical properties such as long-term stability, transfer property and image uniformity. Furthermore, an amount of an external additive, which is added to give regular image uniformity, may be reduced drastically if the spheroidization rate of the toner core particles is controlled within the range as described above.

In order to accomplish the above objects of the present invention, it is preferred to coat surfaces of the toner core particles having the above advantageous effects with an external additive. That is, the above objects of the present invention may be accomplished by coating surfaces of the toner core particle with silica and titanium dioxide, all of which have different particle sizes as the external additive, in order to ensure image uniformity by further enhancing lubrication properties of toner, having high chargeability as well as narrow charge distribution, decrease image contamination, and improve physical properties such as long-term stability, transfer property and image uniformity. In this case, the organic powder particles having higher sphericity may be more advantageous.

Among the external additives, organic powder having different particle size functions to enhance chargeability and charge-maintaining ability by adjusting friction between a sleeve and a doctor blade to a suitable friction level. That is, the organic powder has an important effect to decrease a frictional force between toner and a doctor blade since the organic powder has a finer particle size than the above-mentioned spherical toner core particles. Also, the organic powder does not have bad effects on a charge state of the toner core particles due to its own insulating characteristics, and is advantageous to maintain a charged state of a drum with high chargeability.

In particular, reasons of adding organic powder with different particle size to surfaces of the toner core particles are to further improve friction characteristics of the toner core particles, as well as to further enhance the above-mentioned charge-maintaining ability by filling small spherical organic powder between gaps that are formed when the surfaces of the toner core particles are coated only with spherical organic powder of a large particle size. Also, the addition of the organic powder with different particle size functions to prevent high chargeability of toner being deteriorated when printouts proceeds for an extended period using the particles with different particle sizes. Hereinafter, the expression average particle size means a diameter (volume average particle size) when calculated into diameter of spheres.

On the basis of the above reasons, the large particles in the organic particles preferably have an average particle size of 600 to 1000 nm, and the small particles preferably have an average particle size of 50 to 120 nm.

The organic powder having different particle size includes polytetrafluoroethylene (PTFE), polymethylmethacrylate (PMMA), polyvinylidene fluoride (PVDF), styrene acrylate, polyester particles, silicon particles and styrene-methyl methacrylate (ST-MMA), and the use of the compounds is advantageous to produce a surface of a spherical toner, whose charging characteristics are uniformly distributed when compared to the toner of irregular shapes, into a toner having high chargeability, the spherical toner being uniformly distributed in, compared to the toner of irregular shapes.

For the organic powder particles, the large particles and the small particles are desirably used respectively in contents of 0.4 to 1.0 part by weight and 0.4 to 2.0 parts by weight, based on 100 parts by weight of the toner core particles. Physical properties of toner are slight when the contents are less than 0.4 parts by weight, whereas a primary charge roller (PCR) may be contaminated or the charging of toner may be rather prevented due to the presence of the excessive large and small particles when the contents exceeds 1 and 2 parts by weight, respectively. Therefore, it is impossible to achieve the objects of the present invention regarding the production of toner with high chargeability.

By mixing organic powders having different particle sizes with the spheroidized toner to control friction between a sleeve and a doctor blade to a suitable extent, spherical toner having high chargeability and excellent charge-maintaining ability was produced. However, the toner produced thus has high chargeability and charge-maintaining ability but shows extremely low chargeability or extremely high charging characteristics due to the wide charge distribution, and therefore transfer characteristics of the toner may be deteriorated and background contamination and edge contamination may be increasingly caused.

To solve the problem regarding the deterioration of such image characteristics, phenomena such as the background contamination and the edge contamination are prevented in the present invention by applying spherical titanium dioxide to maintain charge distribution of the toner particles to a narrow extent (a sharp shape of a distribution curve). The spherical titanium dioxide more preferably has a spheroidization rate of 0.6 or more. When titanium dioxide having a spheroidization rate of 0.6 or less is used, PCR or a drum may be contaminated due to the insufficient adhesion between the titanium dioxide and the toner core particles.

This titanium dioxide may have various shapes, for example a stable phase such as an anatase phase, a rutile phase or the like, or a semistable phase such as a brookite phase or the like, depending on the shape of the titanium dioxide, but a rutile phase is preferred when the titanium dioxide is suitable for the use in the present invention.

Also, the titanium dioxide preferably has an average particle size of 300 to 1000 nm. When the average particle size of the titanium dioxide exceeds 1000 m, adhesive properties to the toner particle surface may be deteriorated due to the extremely increased particle size. When the average particle size is less than 30 nm, the titanium dioxide has a poor ability to control the charge distribution, which makes it difficult to ensure desired uniformity in the charge distribution.

By using this shape of the titanium dioxide particles to adjust charge distribution of toner to a narrow extent, that is, to adjust a charge amount of reverse-polar or poorly charged particles and extremely charged particles, phenomena such as the background contamination and the edge contamination caused by the charged particles may not appear even when the toner is printed for an extended period, and it is also possible to maintain an uniform image.

The titanium dioxide particles having the above-mentioned advantageous effects preferably has a content of 1.5 to 4 parts by weight, based on 100 parts by weight of the toner core particles. Here, when the content of the titanium dioxide particles is less than 1.5 parts by weight, the addition effects of the titanium dioxide is insignificant due to the low content of the titanium dioxide, whereas, when the content of the titanium dioxide particles exceeds 4 parts by weight, the toner core particles may be not poorly coated due to the presence of the excessive titanium dioxide, and the excessive titanium dioxide causes damages, such as scratches, to a surface of a photoconductive drum in some cases, which leads to the secondary contamination. Accordingly, the content of the titanium dioxide particles is preferably adjusted to the above-mentioned content range to prevent these adverse influences.

Separately from the above context, it is also preferred to coat surfaces of the toner core particles with silica particles in the present invention. The silica particles function to control an adhesive force of the toner according to the present invention. That is, when toner in which toner core particles are coated with silica particles is provided, the toner may be easily detached from a charged drum and transferred to an image-receiving paper or an intermediate transfer body, and mobility of the toner may be promoted due to the reduced adhesive force between the toners.

In this case, the silica preferably has a particle size of 5 to 20 nm. The silica with very small particle size of 5 nm or less may be embedded into a surface of the toner in the long term, and an external additive may be peel off form the toner particles. Therefore, the silica with very small particle size may degrade an anti-agglomeration ability between particles, and thus have adverse effects on the charging characteristics of the toner. And, when the particle size of the silica exceeds 20 nm, the toner particles may be coated insufficiently, and also does not function as a flow agent, which leads to the reduced fluidity of the toner particles. Therefore, the toner may be recognized to be in short even though toner remains in a cartridge in the actual use of the toner. Accordingly, the silica particles whose particle size ranges from 5 to 20 nm is preferably used in the spheroidized toner of the present invention.

This content of the silica particles is desirably in a range of 2 to 4 parts by weight, based on 100 parts by weight of the toner core particles. When the content of the silica particles is less than 2 parts by weight, the silica does not suitably function as the flow agent, whereas side effects such as poor fusion ability may appear when the content of the silica particles exceeds 4 parts by weight.

As described above, the toner according to the present invention includes toner core particles and an external additive composed of organic powder particles, spherical titanium dioxide particles (spheroidization rate of 0.6 or more) and silica. The toner according to the present invention has an average particle size of 10 μm or less, preferably an average particle size of 3 to 9 μm. A non-image portion of the toner may be seriously contained when the average particle size of the toner is less than 3 μm, whereas image resolution may be deteriorated and print recovery rate may be low when the average particle size exceeds 10 μm.

For the toner according to the present invention, the toner core particle may include a binder resin and a coloring agent, and further include all kinds of additives that may be added as other additives of the toner core particles within the range in which the additives do not damages to the properties of the toner core particles as described above.

The binder resin includes acrylic acid ester polymers such as polymethylacrylate, polyethylacrylate, polybutylacrylate, poly(2-ethyl hexyl acrylate), or polylaurylacrylate; methacrylic acid ester polymer such as polymethyl methacrylate, polybutyl methacrylate, polyhexyl methacrylate, poly(2-ethyl hexyl methacrylate) or polylauryl methacrylate; co-polymers of acrylic acid ester and methacrylic acid ester; co-polymers of styrene monomer and acrylic acid ester or methacrylic acid ester; ethylene polymers such as polyvinyl acetate, polyvinyl propionate, polyvinyl butyrate, polyethylene or polypropylene, and co-polymers thereof; styrene co-polymers such as styrene/butadien co-polymer, styrene/isoprene co-polymer, or styrene/maleic acid co-polymer; polystyrene resins; polyvinyl ether resins; polyvinyl ketone resins; polyester resins; polyurethane resins; epoxy resins; or silicon resins, etc., and they may be used alone or in combinations thereof. Polystyrene resins, polyester resins, polyethylene resins, polypropylene resins, styrene/alkyl acrylate co-polymers, styrene/alkyl methacrylate co-polymers, styrene/acrylonitrile co-polymers, styrene/butadien co-polymers, styrene/maleic acid co-polymer are preferably used.

Carbon black, magnetic powder, dyes or pigments may be used as the coloring agent, and representative examples of the coloring agent include nigrosine dye, Aniline Blue, Carcoil Blue, Chrome Yellow, Ultramarine Blue, Dupont Oil Red, Methylene Blue Chlorides, Phthalocyanine Blue, Lamp Black, Rose bengal, C.I. pigment Red 48:1, C.I. pigment Red 48:4, C.I. pigment Red 122, C.I. pigment Red 57:1, C.I. Pigment Red 257, C.I. Pigment Red 296, C.I. Pigment Yellow 97, C.I. Pigment Yellow 12, C.I. Pigment Yellow 17, C.I. Pigment Yellow 14, C.I. Pigment Yellow 13, C.I. Pigment Yellow 16, C.I. Pigment Yellow 81, C.I. Pigment Yellow 126, C.I. Pigment Yellow 127, C.I. Pigment Blue 9, C.I. Pigment Blue 15, C.I. Pigment Blue 15:1, or C.I. Pigment Blue 15:3, etc.

Also, the toner core particles according to the present invention may further include a release agent and a charge control agent.

Polyethylene wax, polypropylene wax or the like, which has a low molecular weight, may be generally used as the release agent. Also, the charge control agent, which may be used herein, includes chromium-containing azo metal complexes, metal complexes of salicylic acid, chromium-containing organic dye, or quaternary ammonium salt, styrene acrylic resin-type charge control agent, etc.

As described above, the non-magnetic one-component color toner according to the present invention is preferably applied to indirect transfer- or tandem-type high-speed color printers that have been increasingly used owing to the recent increased demand for color expression and high speed.

The toner composition according to the present invention and the production method thereof have been described in detail. Hereinafter, the toner composition of the present invention and the production method thereof will be described in more detail through more specific exemplary embodiments. However, it is considered that the description proposed herein is just an exemplary example for the purpose of illustrations only, not intended to limit the scope of the invention. Rather, the scope of the present invention shall be defined by the appended claims and equivalents thereof.

### MODE FOR THE INVENTION

### 1. Production of Toner

Each of the toners according to Examples and Comparative examples was produced by varying the conditions of spheroidization rate, organic powder A, organic powder B, silica and titanium dioxide as listed in the following Tables 1 and 2.

1-1. Production of Magenta Toner Core Particles

92 parts by weight of polyester resin (molecular weight: 2.5×104), 5 parts by weight of quinacridone Red 122, 5 parts by weight of resin type CCA and 2 parts by weight of low molecular weight polypropylene were mixed in a Henschel mixer. The resulting mixture was melted and kneaded at 155° C. in a twin-screw melt kneader, and grinded into fine particles using a Jet mill pulverizer, and then classified with an air jet classifier to produce toner core particle having a volume average particle size of 8.0 μm.

1-2. Production of Spheroidized Color Toner

The toner core particles produced thus were spheroidized using the mechanical process. In this case, spheroidization rates of the toners were adjusted to different extents according to each of the Examples and Comparative examples, and the toner particles were spheroidized at a rotary speed 8000 rpm for a varying spheroidization time according to the mechanical process. It was revealed that the spheroidization time was varied according to the quality of the toner core particles, the original spheroidization rate and the desired spheroidization rate, but, as one example of using the toner core particles prepared under the above-mentioned conditions, the spheroidization time was adjusted to 4, 8, 12, 18, 30, 40 and 60 minutes with an increasing spheroidization rate of 0.2, 0.4, 0.6, 0.7, 0.8, 0.9 and 1.0, respectively.

1-3. Production of Non-Magnetic One-Component Color Toner Particles

In order to coat surfaces of toner core particles produced in the production examples, 100 parts by weight of the toner core particles were injected into a hybridizer, and PTFE, PMMA or PVDF powder, octyl silane-modified silica powder and rutile-phase titanium dioxide were added in contents as listed in the following Tables 1 and 2, and then stirred at a rotary speed of 5000 rpm for 5 minutes to produce toner particles.

TABLE 1

| | Spheroidization | Spherical organic powder A | | |
|---|---|---|---|---|
| | rate | Spherical organic powder B | Silica | Titanium dioxide |
| Example 1 | 0.7 | 100 nm PMMA 0.5 parts by | 6 nm silica 2.0 | 900 nm titanium dioxide 3.0 |
| | | weight | parts by weight | parts by weight |
| | | 800 nm PMMA 1.0 parts by | | |
| | | weight | | |
| Example 2 | 0.6 | 60 nm PMMA 0.8 parts by | 6 nm silica 2.5 | 500 nm titanium dioxide 4.0 |
| | | weight | parts by weight | parts by weight |
| | | 800 nm PMMA 1.5 parts by | | |
| | | weight | | |
| Example 3 | 0.6 | 60 nm PMMA 0.8 parts by | 6 nm silica 2.5 | 800 nm titanium dioxide 2.0 |
| | | weight | parts by weight | parts by weight |
| | | 800 nm PMMA 1.5 parts by | | |
| | | weight | | |
| Example 4 | 0.6 | 60 nm PMMA 0.8 parts by | 6 nm silica 2.5 | 800 nm titanium dioxide 4.0 |
| | | weight | parts by weight | parts by weight |
| | | 800 nm PMMA 1.5 parts by | | |
| | | weight | | |
| Example 5 | 0.6 | 60 nm PMMA 0.8 parts by | 16 nm silica 2.5 | 500 nm titanium dioxide 2.0 |
| | | weight | parts by weight | parts by weight |
| | | 800 nm PMMA 1.5 parts by | | |
| | | weight | | |
| Example 6 | 0.6 | 60 nm PMMA 0.8 parts by | 16 nm silica 2.5 | 500 nm titanium dioxide 4.0 |
| | | weight | parts by weight | parts by weight |
| | | 800 nm PMMA 1.5 parts by | | |
| | | weight | | |
| Example 7 | 0.6 | 60 nm PMMA 0.8 parts by | 16 nm silica 2.5 | 800 nm titanium dioxide 2.0 |
| | | weight | parts by weight | parts by weight |
| | | 800 nm PMMA 1.5 parts by | | |
| | | weight | | |
| Example 8 | 0.6 | 60 nm PMMA 0.8 parts by | 16 nm silica 2.5 | 800 nm titanium dioxide 4.0 |
| | | weight | parts by weight | parts by weight |
| | | 800 nm PMMA 1.5 parts by | | |
| | | weight | | |
| Example 9 | 0.6 | 60 nm PMMA 0.8 parts by | 6 nm silica 3.5 | 500 nm titanium dioxide 2.0 |
| | | weight | parts by weight | parts by weight |
| | | 800 nm PMMA 1.5 parts by | | |
| | | weight | | |
| Example | 0.6 | 60 nm PMMA 0.8 parts by | 6 nm silica 3.5 | 500 nm titanium dioxide 4.0 |
| 10 | | weight | parts by weight | parts by weight |
| | | 800 nm PMMA 1.5 parts by | | |
| | | weight | | |
| Example | 0.6 | 60 nm PMMA 0.8 parts by | 6 nm silica 3.5 | 800 nm titanium dioxide 2.0 |
| 11 | | weight | parts by weight | parts by weight |
| | | 800 nm PMMA 1.5 parts by | | |
| | | weight | | |
| Example | 0.6 | 60 nm PMMA 0.8 parts by | 6 nm silica 3.5 | 800 nm titanium dioxide 4.0 |
| 12 | | weight | parts by weight | parts by weight |
| | | 800 nm PMMA 1.5 parts by | | |
| | | weight | | |
| Example | 0.6 | 60 nm PMMA 0.8 parts by | 16 nm silica 3.5 | 500 nm titanium dioxide 2.0 |
| 13 | | weight | parts by weight | parts by weight |
| | | 800 nm PMMA 1.5 parts by | | |
| | | weight | | |
| Example | 0.6 | 60 nm PMMA 0.8 parts by | 16 nm silica 3.5 | 500 nm titanium dioxide 4.0 |
| 14 | | weight | parts by weight | parts by weight |
| | | 800 nm PMMA 1.5 parts by | | |
| | | weight | | |
| Example | 0.6 | 60 nm PMMA 0.8 parts by | 16 nm silica 3.5 | 800 nm titanium dioxide 2.0 |
| 15 | | weight | parts by weight | parts by weight |
| | | 800 nm PMMA 1.5 parts by | | |
| | | weight | | |
| Example | 0.6 | 60 nm PMMA 0.8 parts by | 16 nm silica 3.5 | 800 nm titanium dioxide 4.0 |
| 16 | | weight | parts by weight | parts by weight |
| | | 800 nm PMMA 1.5 parts by | | |
| | | weight | | |
| Example | 0.8 | 100 nm PTFE 0.5 parts by | 6 nm silica 2.5 | 500 nm titanium dioxide 2.0 |
| 17 | | weight | parts by weight | parts by weight |
| | | 900 nm PTFE 0.5 parts by | | |
| | | weight | | |
| Example | 0.8 | 100 nm PTFE 0.5 parts by | 6 nm silica 2.5 | 500 nm titanium dioxide 4.0 |
| 18 | | weight | parts by weight | parts by weight |
| | | 900 nm PTFE 0.5 parts by | | |
| | | weight | | |
| Example | 0.8 | 100 nm PTFE 0.5 parts by | 6 nm silica 2.5 | 800 nm titanium dioxide 2.0 |
| 19 | | weight | parts by weight | parts by weight |
| | | 900 nm PTFE 0.5 parts by | | |
| | | weight | | |
| Example | 0.8 | 100 nm PTFE 0.5 parts by | 6 nm silica 2.5 | 800 nm titanium dioxide 4.0 |
| 20 | | weight | parts by weight | parts by weight |
| | | 900 nm PTFE 0.5 parts by | | |
| | | weight | | |
| Example | 0.8 | 100 nm PTFE 0.5 parts by | 16 nm silica 2.5 | 500 nm titanium dioxide 2.0 |
| 21 | | weight | parts by weight | parts by weight |
| | | 900 nm PTFE 0.5 parts by | | |
| | | weight | | |
| Example | 0.8 | 100 nm PTFE 0.5 parts by | 16 nm silica 2.5 | 500 nm titanium dioxide 4.0 |
| 22 | | weight | parts by weight | parts by weight |
| | | 900 nm PTFE 0.5 parts by | | |
| | | weight | | |
| Example | 0.8 | 100 nm PTFE 0.5 parts by | 16 nm silica 2.5 | 800 nm titanium dioxide 2.0 |
| 23 | | weight | parts by weight | parts by weight |
| | | 900 nm PTFE 0.5 parts by | | |
| | | weight | | |
| Example | 0.8 | 100 nm PTFE 0.5 parts by | 16 nm silica 2.5 | 800 nm titanium dioxide 4.0 |
| 24 | | weight | parts by weight | parts by weight |
| | | 900 nm PTFE 0.5 parts by | | |
| | | weight | | |
| Example | 0.8 | 100 nm PTFE 0.5 parts by | 6 nm silica 3.5 | 500 nm titanium dioxide 2.0 |
| 25 | | weight | parts by weight | parts by weight |
| | | 900 nm PTFE 0.5 parts by | | |
| | | weight | | |
| Example | 0.8 | 100 nm PTFE 0.5 parts by | 6 nm silica 3.5 | 500 nm titanium dioxide 4.0 |
| 26 | | weight | parts by weight | parts by weight |
| | | 900 nm PTFE 0.5 parts by | | |
| | | weight | | |
| Example | 0.8 | 100 nm PTFE 0.5 parts by | 6 nm silica 3.5 | 800 nm titanium dioxide 2.0 |
| 27 | | weight | parts by weight | parts by weight |
| | | 900 nm PTFE 0.5 parts by | | |
| | | weight | | |
| Example | 0.8 | 100 nm PTFE 0.5 parts by | 6 nm silica 3.5 | 800 nm titanium dioxide 4.0 |
| 28 | | weight | parts by weight | parts by weight |
| | | 900 nm PTFE 0.5 parts by | | |
| | | weight | | |
| Example | 0.8 | 100 nm PTFE 0.5 parts by | 16 nm silica 3.5 | 500 nm titanium dioxide 2.0 |
| 29 | | weight | parts by weight | parts by weight |
| | | 900 nm PTFE 0.5 parts by | | |
| | | weight | | |
| Example | 0.8 | 100 nm PTFE 0.5 parts by | 16 nm silica 3.5 | 500 nm titanium dioxide 4.0 |
| 30 | | weight | parts by weight | parts by weight |
| | | 900 nm PTFE 0.5 parts by | | |
| | | weight | | |
| Example | 0.8 | 100 nm PTFE 0.5 parts by | 16 nm silica 3.5 | 800 nm titanium dioxide 2.0 |
| 31 | | weight | parts by weight | parts by weight |
| | | 900 nm PTFE 0.5 parts by | | |
| | | weight | | |
| Example | 0.8 | 100 nm PTFE 0.5 parts by | 16 nm silica 3.5 | 800 nm titanium dioxide 4.0 |
| 32 | | weight | parts by weight | parts by weight |
| | | 900 nm PTFE 0.5 parts by | | |
| | | weight | | |
| Example | 0.6 | 70 nm PMMA 0.5 parts by | 6 nm silica 2.5 | 500 nm titanium dioxide 2.0 |
| 33 | | weight | parts by weight | parts by weight |
| | | 700 nm PVDF 1.8 parts by | | |
| | | weight | | |
| Example | 0.6 | 70 nm PMMA 0.5 parts by | 6 nm silica 2.5 | 500 nm titanium dioxide 4.0 |
| 34 | | weight | parts by weight | parts by weight |
| | | 700 nm PVDF 1.8 parts by | | |
| | | weight | | |
| Example | 0.6 | 70 nm PMMA 0.5 parts by | 6 nm silica 2.5 | 800 nm titanium dioxide 2.0 |
| 35 | | weight | parts by weight | parts by weight |
| | | 700 nm PVDF 1.8 parts by | | |
| | | weight | | |
| Example | 0.6 | 70 nm PMMA 0.5 parts by | 6 nm silica 2.5 | 800 nm titanium dioxide 4.0 |
| 36 | | weight | parts by weight | parts by weight |
| | | 700 nm PVDF 1.8 parts by | | |
| | | weight | | |
| Example | 0.6 | 70 nm PMMA 0.5 parts by | 6 nm silica 2.5 | 500 nm titanium dioxide 2.0 |
| 37 | | weight | parts by weight | parts by weight |
| | | 700 nm PVDF 1.8 parts by | | |
| | | weight | | |
| Example | 0.6 | 70 nm PMMA 0.5 parts by | 16 nm silica 3.5 | 500 nm titanium dioxide 4.0 |
| 38 | | weight | parts by weight | parts by weight |
| | | 700 nm PVDF 1.8 parts by | | |
| | | weight | | |
| Example | 0.6 | 70 nm PMMA 0.5 parts by | 16 nm silica 3.5 | 800 nm titanium dioxide 2.0 |
| 39 | | weight | parts by weight | parts by weight |
| | | 700 nm PVDF 1.8 parts by | | |
| | | weight | | |
| Example | 0.6 | 70 nm PMMA 0.5 parts by | 16 nm silica 3.5 | 800 nm titanium dioxide 4.0 |
| 40 | | weight | parts by weight | parts by weight |
| | | 700 nm PVDF 1.8 parts by | | |
| | | weight | | |
| Example | 0.6 | 70 nm PMMA 0.5 parts by | 16 nm silica 3.5 | 500 nm titanium dioxide 2.0 |
| 41 | | weight | parts by weight | parts by weight |
| | | 700 nm PVDF 1.8 parts by | | |
| | | weight | | |
| Example | 0.6 | 70 nm PMMA 0.5 parts by | 16 nm silica 3.5 | 500 nm titanium dioxide 4.0 |
| 42 | | weight | parts by weight | parts by weight |
| | | 700 nm PVDF 1.8 parts by | | |
| | | weight | | |
| Example | 0.6 | 70 nm PMMA 0.5 parts by | 16 nm silica 3.5 | 800 nm titanium dioxide 2.0 |
| 43 | | weight | parts by weight | parts by weight |
| | | 700 nm PVDF 1.8 parts by | | |
| | | weight | | |
| Example | 0.6 | 70 nm PMMA 0.5 parts by | 16 nm silica 3.5 | 800 nm titanium dioxide 4.0 |
| 44 | | weight | parts by weight | parts by weight |
| | | 700 nm PVDF 1.8 parts by | | |
| | | weight | | |
| Example | 0.6 | 70 nm PMMA 0.5 parts by | 16 nm silica 3.5 | 500 nm titanium dioxide 2.0 |
| 45 | | weight | parts by weight | parts by weight |
| | | 700 nm PVDF 1.8 parts by | | |
| | | weight | | |
| Example | 0.6 | 70 nm PMMA 0.5 parts by | 16 nm silica 3.5 | 500 nm titanium dioxide 4.0 |
| 46 | | weight | parts by weight | parts by weight |
| | | 700 nm PVDF 1.8 parts by | | |
| | | weight | | |
| Example | 0.6 | 70 nm PMMA 0.5 parts by | 16 nm silica 3.5 | 800 nm titanium dioxide 2.0 |
| 47 | | weight | parts by weight | parts by weight |
| | | 700 nm PVDF 1.8 parts by | | |
| | | weight | | |
| Example | 0.6 | 70 nm PMMA 0.5 parts by | 16 nm silica 3.5 | 800 nm titanium dioxide 4.0 |
| 48 | | weight | parts by weight | parts by weight |
| | | 700 nm PVDF 1.8 parts by | | |
| | | weight | | |
| Example | 0.8 | 110 nm PTFE 0.9 parts by | 6 nm silica 2.5 | 500 nm titanium dioxide 2.0 |
| 49 | | weight | parts by weight | parts by weight |
| | | 900 nm PVDF 0.5 parts by | | |
| | | weight | | |
| Example | 0.8 | 110 nm PTFE 0.9 parts by | 6 nm silica 2.5 | 500 nm titanium dioxide 4.0 |
| 50 | | weight | parts by weight | parts by weight |
| | | 900 nm PVDF 0.5 parts by | | |
| | | weight | | |
| Example | 0.8 | 110 nm PTFE 0.9 parts by | 6 nm silica 2.5 | 800 nm titanium dioxide 2.0 |
| 51 | | weight | parts by weight | parts by weight |
| | | 900 nm PVDF 0.5 parts by | | |
| | | weight | | |
| Example | 0.8 | 110 nm PTFE 0.9 parts by | 6 nm silica 2.5 | 800 nm titanium dioxide 4.0 |
| 52 | | weight | parts by weight | parts by weight |
| | | 900 nm PVDF 0.5 parts by | | |
| | | weight | | |
| Example | 0.8 | 110 nm PTFE 0.9 parts by | 6 nm silica 2.5 | 500 nm titanium dioxide 2.0 |
| 53 | | weight | parts by weight | parts by weight |
| | | 900 nm PVDF 0.5 parts by | | |
| | | weight | | |
| Example | 0.8 | 110 nm PTFE 0.9 parts by | 16 nm silica 3.5 | 500 nm titanium dioxide 4.0 |
| 54 | | weight | parts by weight | parts by weight |
| | | 900 nm PVDF 0.5 parts by | | |
| | | weight | | |
| Example | 0.8 | 110 nm PTFE 0.9 parts by | 16 nm silica 3.5 | 800 nm titanium dioxide 2.0 |
| 55 | | weight | parts by weight | parts by weight |
| | | 900 nm PVDF 0.5 parts by | | |
| | | weight | | |
| Example | 0.8 | 110 nm PTFE 0.9 parts by | 16 nm silica 3.5 | 800 nm titanium dioxide 4.0 |
| 56 | | weight | parts by weight | parts by weight |
| | | 900 nm PVDF 0.5 parts by | | |
| | | weight | | |
| Example | 0.8 | 110 nm PTFE 0.9 parts by | 16 nm silica 3.5 | 500 nm titanium dioxide 2.0 |
| 57 | | weight | parts by weight | parts by weight |
| | | 900 nm PVDF 0.5 parts by | | |
| | | weight | | |
| Example | 0.8 | 110 nm PTFE 0.9 parts by | 16 nm silica 3.5 | 500 nm titanium dioxide 4.0 |
| 58 | | weight | parts by weight | parts by weight |
| | | 900 nm PVDF 0.5 parts by | | |
| | | weight | | |
| Example | 0.8 | 110 nm PTFE 0.9 parts by | 16 nm silica 3.5 | 800 nm titanium dioxide 2.0 |
| 59 | | weight | parts by weight | parts by weight |
| | | 900 nm PVDF 0.5 parts by | | |
| | | weight | | |
| Example | 0.8 | 110 nm PTFE 0.9 parts by | 16 nm silica 3.5 | 800 nm titanium dioxide 4.0 |
| 60 | | weight | parts by weight | parts by weight |
| | | 900 nm PVDF 0.5 parts by | | |
| | | weight | | |
| Example | 0.8 | 110 nm PTFE 0.9 parts by | 16 nm silica 3.5 | 500 nm titanium dioxide 2.0 |
| 61 | | weight | parts by weight | parts by weight |
| | | 900 nm PVDF 0.5 parts by | | |
| | | weight | | |
| Example | 0.8 | 110 nm PTFE 0.9 parts by | 16 nm silica 3.5 | 500 nm titanium dioxide 4.0 |
| 62 | | weight | parts by weight | parts by weight |
| | | 900 nm PVDF 0.5 parts by | | |
| | | weight | | |
| Example | 0.8 | 110 nm PTFE 0.9 parts by | 16 nm silica 3.5 | 800 nm titanium dioxide 2.0 |
| 63 | | weight | parts by weight | parts by weight |
| | | 900 nm PVDF 0.5 parts by | | |
| | | weight | | |
| Example | 0.8 | 110 nm PTFE 0.9 parts by | 16 nm silica 3.5 | 800 nm titanium dioxide 4.0 |
| 64 | | weight | parts by weight | parts by weight |
| | | 900 nm PVDF 0.5 parts by | | |
| | | weight | | |

TABLE 2

| | | spherical organic | | |
|---|---|---|---|---|
| | | powder A | | |
| | spheroidization | spherical organic | | |
| | rate | powder B | silica | titanium dioxide |
| Comparative | — | — | 7 nm silica 2.0 parts | 200 nm titanium dioxide 1.0 |
| example 1 | | | by weight | parts by weight |
| Comparative | 0.8 | — | 6 nm silica 2.5 parts | 500 nm titanium dioxide 4.0 |
| example 2 | | | by weight | parts by weight |
| Comparative | 0.8 | — | 6 nm silica 2.5 parts | 800 nm titanium dioxide 2.0 |
| example 3 | | | by weight | parts by weight |
| Comparative | 0.8 | — | 6 nm silica 2.5 parts | 800 nm titanium dioxide 4.0 |
| example 4 | | | by weight | parts by weight |
| Comparative | 0.8 | — | 16 nm silica 2.5 parts | 500 nm titanium dioxide 2.0 |
| example 5 | | | by weight | parts by weight |
| Comparative | 0.8 | — | 16 nm silica 2.5 parts | 500 nm titanium dioxide 4.0 |
| example 6 | | | by weight | parts by weight |
| Comparative | 0.8 | — | 16 nm silica 2.5 parts | 800 nm titanium dioxide 2.0 |
| example 7 | | | by weight | parts by weight |
| Comparative | 0.7 | 30 nm PMMA 0.2 | 40 nm silica 1.0 parts | 200 nm titanium dioxide 1.0 |
| example 8 | | parts by weight | by weight | parts by weight |
| | | 200 nm PMMA 0.2 | | |
| | | parts by weight | | |
| Comparative | 0.8 | 30 nm PMMA 0.2 | 40 nm silica 1.0 parts | 200 nm titanium dioxide 5.0 |
| example 9 | | parts by weight | by weight | parts by weight |
| | | 200 nm PMMA 0.2 | | |
| | | parts by weight | | |
| Comparative | 0.8 | 30 nm PMMA 0.2 | 40 nm silica 1.0 parts | 100 nm titanium dioxide 1.0 |
| example 10 | | parts by weight | by weight | parts by weight |
| | | 200 nm PMMA 0.2 | | |
| | | parts by weight | | |
| Comparative | 0.8 | 30 nm PMMA 0.2 | 40 nm silica 1.0 parts | 100 nm titanium dioxide 5.0 |
| example 11 | | parts by weight | by weight | parts by weight |
| | | 200 nm PMMA 0.2 | | |
| | | parts by weight | | |
| Comparative | 0.8 | 30 nm PMMA 0.2 | 40 nm silica 1.0 parts | 1200 nm titanium dioxide 1.0 |
| example 12 | | parts by weight | by weight | parts by weight |
| | | 200 nm PMMA 0.2 | | |
| | | parts by weight | | |
| Comparative | 0.8 | 30 nm PMMA 0.2 | 40 nm silica 1.0 parts | 1200 nm titanium dioxide 5.0 |
| example 13 | | parts by weight | by weight | parts by weight |
| | | 200 nm PMMA 0.2 | | |
| | | parts by weight | | |
| Comparative | 0.8 | 30 nm PMMA 0.2 | 40 nm silica 1.0 parts | 500 nm titanium dioxide 2.0 |
| example 14 | | parts by weight | by weight | parts by weight |
| | | 200 nm PMMA 0.2 | | |
| | | parts by weight | | |
| Comparative | 0.8 | 30 nm PMMA 0.2 | 40 nm silica 1.0 parts | 800 nm titanium dioxide 4.0 |
| example 15 | | parts by weight | by weight | parts by weight |
| | | 200 nm PMMA 0.2 | | |
| | | parts by weight | | |
| Comparative | 0.8 | 30 nm PMMA 0.2 | 40 nm silica 1.0 parts | — |
| example 16 | | parts by weight | by weight | |
| | | 200 nm PMMA 0.2 | | |
| | | parts by weight | | |
| Comparative | 0.8 | 30 nm PMMA 0.2 | 40 nm silica 2.0 parts | 20 nm titanium dioxide 0.1 parts |
| example 17 | | parts by weight | by weight | by weight |
| | | 200 nm PMMA 0.2 | | |
| | | parts by weight | | |
| Comparative | 0.2 | 30 nm PMMA 0.2 | 7 nm silica 3.0 parts | 200 nm titanium dioxide 1.0 |
| example 18 | | parts by weight | by weight | parts by weight |
| | | 200 nm PMMA 0.2 | | |
| | | parts by weight | | |
| Comparative | 0.2 | 30 nm PMMA 0.2 | 7 nm silica 3.0 parts | 500 nm titanium dioxide 4.0 |
| example 19 | | parts by weight | by weight | parts by weight |
| | | 200 nm PMMA 0.2 | | |
| | | parts by weight | | |
| Comparative | 0.2 | 30 nm PMMA 0.2 | 7 nm silica 3.0 parts | 800 nm titanium dioxide 2.0 |
| example 20 | | parts by weight | by weight | parts by weight |
| | | 200 nm PMMA 0.2 | | |
| | | parts by weight | | |
| Comparative | 0.2 | 30 nm PMMA 0.2 | 7 nm silica 3.0 parts | 800 nm titanium dioxide 4.0 |
| example 21 | | parts by weight | by weight | parts by weight |
| | | 200 nm PMMA 0.2 | | |
| | | parts by weight | | |
| Comparative | 0.2 | 30 nm PMMA 0.2 | 7 nm silica 3.0 parts | 500 nm titanium dioxide 2.0 |
| example 22 | | parts by weight | by weight | parts by weight |
| | | 200 nm PMMA 0.2 | | |
| | | parts by weight | | |
| Comparative | 0.2 | 30 nm PMMA 0.2 | 7 nm silica 3.0 parts | 500 nm titanium dioxide 4.0 |
| example 23 | | parts by weight | by weight | parts by weight |
| | | 200 nm PMMA 0.2 | | |
| | | parts by weight | | |
| Comparative | 0.2 | 30 nm PMMA 0.2 | 7 nm silica 3.0 parts | 800 nm titanium dioxide 2.0 |
| example 24 | | parts by weight | by weight | parts by weight |
| | | 200 nm PMMA 0.2 | | |
| | | parts by weight | | |
| Comparative | 0.2 | 30 nm PMMA 0.2 | 7 nm silica 3.0 parts | 200 nm titanium dioxide 1.0 |
| example 25 | | parts by weight | by weight | parts by weight |
| | | 200 nm PMMA 0.2 | | |
| | | parts by weight | | |
| Comparative | 0.2 | 150 nm PMMA 0.2 | 7 nm silica 3.0 parts | 500 nm titanium dioxide 3.0 |
| example 26 | | parts by weight | by weight | parts by weight |
| | | 1500 nm PTFE 0.2 | | |
| | | parts by weight | | |
| Comparative | 0.2 | 150 nm PMMA 0.2 | 7 nm silica 3.0 parts | 20 nm titanium dioxide 0.1 parts |
| example 27 | | parts by weight | by weight | by weight |
| | | 1500 nm PTFE 0.2 | | |
| | | parts by weight | | |
| Comparative | 0.2 | 150 nm PMMA 0.2 | 7 nm silica 3.0 parts | 20 nm titanium dioxide 3.0 parts |
| example 28 | | parts by weight | by weight | by weight |
| | | 1500 nm PTFE 0.2 | | |
| | | parts by weight | | |
| Comparative | 0.2 | 150 nm PMMA 0.2 | 7 nm silica 5.0 parts | 500 nm titanium dioxide 0.1 |
| example 29 | | parts by weight | by weight | parts by weight |
| | | 1500 nm PTFE 0.2 | | |
| | | parts by weight | | |
| Comparative | 0.2 | 150 nm PMMA 0.2 | 50 nm silica 2.0 parts | 500 nm titanium dioxide 3.0 |
| example 30 | | parts by weight | by weight | parts by weight |
| | | 1500 nm PTFE 0.2 | | |
| | | parts by weight | | |
| Comparative | 0.2 | 150 nm PMMA 0.2 | 7 nm silica 5.0 parts | 20 nm titanium dioxide 3.0 parts |
| example 31 | | parts by weight | by weight | by weight |
| | | 1500 nm PTFE 0.2 | | |
| | | parts by weight | | |
| Comparative | 0.2 | 150 nm PMMA 0.2 | 50 nm silica 5.0 parts | 500 nm titanium dioxide 3.0 |
| example 32 | | parts by weight | by weight | parts by weight |
| | | 1500 nm PTFE 0.2 | | |
| | | parts by weight | | |
| Comparative | 0.2 | 150 nm PMMA 0.2 | 7 nm silica 2.0 parts | 0.1 μm PVDF 0.5 |
| example 33 | | parts by weight | by weight | |
| | | 1500 nm PTFE 0.2 | | |
| | | parts by weight | | |
| Comparative | 0.7 | 300 nm PVDF 1.5 | 7 nm silica 2.0 parts | 20 nm titanium dioxide 0.1 parts |
| example 34 | | parts by weight | by weight | by weight |
| | | 1500 nm PTFE 2.5 | | |
| | | parts by weight | | |
| Comparative | 0.7 | 300 nm PVDF 1.5 | 7 nm silica 2.0 parts | 20 nm titanium dioxide 3.0 parts |
| example 35 | | parts by weight | by weight | by weight |
| | | 1500 nm PTFE 2.5 | | |
| | | parts by weight | | |
| Comparative | 0.7 | 300 nm PVDF 1.5 | 7 nm silica 2.0 parts | 500 nm titanium dioxide 0.1 |
| example 36 | | parts by weight | by weight | parts by weight |
| | | 1500 nm PTFE 2.5 | | |
| | | parts by weight | | |
| Comparative | 0.7 | 300 nm PVDF 1.5 | 7 nm silica 2.0 parts | 500 nm titanium dioxide 3.0 |
| example 37 | | parts by weight | by weight | parts by weight |
| | | 1500 nm PTFE 2.5 | | |
| | | parts by weight | | |
| Comparative | 0.7 | 300 nm PVDF 1.5 | 7 nm silica 2.0 parts | 20 nm titanium dioxide 0.1 parts |
| example 38 | | parts by weight | by weight | by weight |
| | | 1500 nm PTFE 2.5 | | |
| | | parts by weight | | |
| Comparative | 0.7 | 300 nm PVDF 1.5 | 7 nm silica 2.0 parts | 20 nm titanium dioxide 3.0 parts |
| example 39 | | parts by weight | by weight | by weight |
| | | 1500 nm PTFE 2.5 | | |
| | | parts by weight | | |
| Comparative | 0.7 | 300 nm PVDF 1.5 | 7 nm silica 2.0 parts | 500 nm titanium dioxide 0.1 |
| example 40 | | parts by weight | by weight | parts by weight |
| | | 1500 nm PTFE 2.5 | | |
| | | parts by weight | | |
| Comparative | 0.7 | 300 nm PVDF 1.5 | 7 nm silica 2.0 parts | 500 nm titanium dioxide 3.0 |
| example 41 | | parts by weight | by weight | parts by weight |
| | | 1500 nm PTFE 2.5 | | |
| | | parts by weight | | |
| Comparative | 0.7 | 300 nm PVDF 1.5 | 7 nm silica 2.0 parts | 20 nm titanium dioxide 0.1 parts |
| example 42 | | parts by weight | by weight | by weight |
| | | 1500 nm PTFE 2.5 | | |
| | | parts by weight | | |
| Comparative | 0.4 | 300 nm PVDF 1.5 | 7 nm silica 2.0 parts | 20 nm titanium dioxide 3.0 parts |
| example 43 | | parts by weight | by weight | by weight |
| | | 1500 nm PTFE 2.5 | | |
| | | parts by weight | | |
| Comparative | 0.4 | 300 nm PVDF 1.5 | 7 nm silica 2.0 parts | 500 nm titanium dioxide 0.1 |
| example 44 | | parts by weight | by weight | parts by weight |
| | | 1500 nm PTFE 2.5 | | |
| | | parts by weight | | |
| Comparative | 0.4 | 300 nm PVDF 1.5 | 7 nm silica 2.0 parts | 500 nm titanium dioxide 3.0 |
| example 45 | | parts by weight | by weight | parts by weight |
| | | 1500 nm PTFE 2.5 | | |
| | | parts by weight | | |
| Comparative | 0.4 | 300 nm PVDF 1.5 | 50 nm silica 2.0 parts | 20 nm titanium dioxide 0.1 parts |
| example 46 | | parts by weight | by weight | by weight |
| | | 1500 nm PTFE 2.5 | | |
| | | parts by weight | | |
| Comparative | 0.4 | 300 nm PVDF 0.2 | 50 nm silica 5.0 parts | 20 nm titanium dioxide 3.0 parts |
| example 47 | | parts by weight | by weight | by weight |
| | | 1500 nm PTFE 0.2 | | |
| | | parts by weight | | |
| Comparative | 0.4 | 300 nm PVDF 0.2 | 16 nm silica 5.0 parts | 500 nm titanium dioxide 0.1 |
| example 48 | | parts by weight | by weight | parts by weight |
| | | 1500 nm PTFE 0.2 | | |
| | | parts by weight | | |
| Comparative | 0.4 | 300 nm PVDF 0.2 | 16 nm silica 5.0 parts | 500 nm titanium dioxide 3.0 |
| example 49 | | parts by weight | by weight | parts by weight |
| | | 1500 nm PTFE 0.2 | | |
| | | parts by weight | | |
| Comparative | 0.4 | 300 nm PVDF 0.2 | 50 nm silica 2.0 parts | 20 nm titanium dioxide 0.1 parts |
| example 50 | | parts by weight | by weight | by weight |
| | | 1500 nm PTFE 0.2 | | |
| | | parts by weight | | |
| Comparative | 0.4 | 300 nm PVDF 0.2 | 50 nm silica 5.0 parts | 20 nm titanium dioxide 3.0 parts |
| example 51 | | parts by weight | by weight | by weight |
| | | 1500 nm PTFE 0.2 | | |
| | | parts by weight | | |
| Comparative | 0.4 | 100 nm PMMA 1.5 | 16 nm silica 5.0 parts | 500 nm titanium dioxide 0.1 |
| example 52 | | parts by weight | by weight | parts by weight |
| | | 800 nm PTFE 2.5 | | |
| | | parts by weight | | |
| Comparative | 0.4 | 100 nm PMMA 1.5 | 16 nm silica 5.0 parts | 500 nm titanium dioxide 3.0 |
| example 53 | | parts by weight | by weight | parts by weight |
| | | 800 nm PTFE 2.5 | | |
| | | parts by weight | | |
| Comparative | 0.4 | 100 nm PMMA 1.5 | 50 nm silica 5.0 parts | 140 nm titanium dioxide 1.0 |
| example 54 | | parts by weight | by weight | parts by weight |
| | | 800 nm PTFE 2.5 | | |
| | | parts by weight | | |
| Comparative | 1.0 | 100 nm PMMA 1.5 | 16 nm silica 5.0 parts | 250 nm titanium dioxide 0.5 |
| example 55 | | parts by weight | by weight | parts by weight |
| | | 800 nm PTFE 2.5 | | |
| | | parts by weight | | |
| Comparative | 1.0 | 100 nm PMMA 1.5 | 7 nm silica 2.0 parts | 500 nm titanium dioxide 2.0 |
| example 56 | | parts by weight | by weight | parts by weight |
| | | 800 nm PTFE 2.5 | | |
| | | parts by weight | | |
| Comparative | 1.0 | 100 nm PMMA 1.5 | 7 nm silica 2.0 parts | 500 nm titanium dioxide 4.0 |
| example 57 | | parts by weight | by weight | parts by weight |
| | | 800 nm PTFE 2.5 | | |
| | | parts by weight | | |
| Comparative | 1.0 | 100 nm PMMA 1.5 | 7 nm silica 2.0 parts | 800 nm titanium dioxide 2.0 |
| example 58 | | parts by weight | by weight | parts by weight |
| | | 800 nm PTFE 2.5 | | |
| | | parts by weight | | |
| Comparative | 1.0 | 100 nm PMMA 1.5 | 7 nm silica 5.0 parts | 200 nm titanium dioxide 1.0 |
| example 59 | | parts by weight | by weight | parts by weight |
| | | 800 nm PTFE 2.5 | | |
| | | parts by weight | | |
| Comparative | 1.0 | 100 nm PMMA 1.5 | 7 nm silica 2.0 parts | 200 nm titanium dioxide 5.0 |
| example 60 | | parts by weight | by weight | parts by weight |
| | | 800 nm PTFE 2.5 | | |
| | | parts by weight | | |
| Comparative | 1.0 | 100 nm PMMA 1.5 | 7 nm silica 2.0 parts | 100 nm titanium dioxide 1.0 |
| example 61 | | parts by weight | by weight | parts by weight |
| | | 800 nm PTFE 2.5 | | |
| | | parts by weight | | |
| Comparative | 1.0 | 100 nm PMMA 1.5 | 7 nm silica 2.0 parts | 100 nm titanium dioxide 5.0 |
| example 62 | | parts by weight | by weight | parts by weight |
| | | 800 nm PTFE 2.5 | | |
| | | parts by weight | | |
| Comparative | 1.0 | 100 nm PMMA 1.5 | 22 nm silica 2.0 parts | 1200 nm titanium dioxide 1.0 |
| example 63 | | parts by weight | by weight | parts by weight |
| | | 800 nm PTFE 2.5 | | |
| | | parts by weight | | |
| Comparative | 1.0 | 100 nm PMMA 1.5 | 22 nm silica 2.0 parts | 500 nm titanium dioxide 2.0 |
| example 64 | | parts by weight | by weight | parts by weight |
| | | 800 nm PTFE 2.5 | | |
| | | parts by weight | | |
| Comparative | 0.9 | 100 nm PMMA 1.5 | 7 nm silica 2.0 parts | 500 nm titanium dioxide 4.0 |
| example 65 | | parts by weight | by weight | parts by weight |
| | | 800 nm PTFE 2.5 | | |
| | | parts by weight | | |
| Comparative | 0.9 | 100 nm PMMA 1.5 | 7 nm silica 2.0 parts | 500 nm titanium dioxide 2.0 |
| example 66 | | parts by weight | by weight | parts by weight |
| | | 800 nm PTFE 2.5 | | |
| | | parts by weight | | |
| Comparative | 0.9 | 100 nm PMMA 1.5 | 7 nm silica 2.0 parts | 500 nm titanium dioxide 4.0 |
| example 67 | | parts by weight | by weight | parts by weight |
| | | 800 nm PTFE 2.5 | | |
| | | parts by weight | | |
| Comparative | 0.9 | 100 nm PMMA 1.5 | 7 nm silica 2.0 parts | 800 nm titanium dioxide 2.0 |
| example 68 | | parts by weight | by weight | parts by weight |
| | | 800 nm PTFE 2.5 | | |
| | | parts by weight | | |
| Comparative | 0.9 | 100 nm PMMA 1.0 | 50 nm silica 3.0 parts | 200 nm titanium dioxide 1.0 |
| example 69 | | parts by weight | by weight | parts by weight |
| | | 800 nm PTFE 2.0 | | |
| | | parts by weight | | |
| Comparative | 0.9 | 100 nm PMMA 1.0 | 50 nm silica 3.0 parts | 200 nm titanium dioxide 5.0 |
| example 70 | | parts by weight | by weight | parts by weight |
| | | 800 nm PTFE 2.0 | | |
| | | parts by weight | | |
| Comparative | 0.9 | 100 nm PMMA 1.0 | 50 nm silica 3.0 parts | 100 nm titanium dioxide 1.0 |
| example 71 | | parts by weight | by weight | parts by weight |
| | | 800 nm PTFE 2.0 | | |
| | | parts by weight | | |
| Comparative | 0.9 | 100 nm PMMA 1.0 | 50 nm silica 3.0 parts | 100 nm titanium dioxide 5.0 |
| example 72 | | parts by weight | by weight | parts by weight |
| | | 800 nm PTFE 2.0 | | |
| | | parts by weight | | |
| Comparative | 0.9 | 100 nm PMMA 1.0 | 50 nm silica 3.0 parts | 1200 nm titanium dioxide 1.0 |
| example 73 | | parts by weight | by weight | parts by weight |
| | | 800 nm PTFE 2.0 | | |
| | | parts by weight | | |
| Comparative | 0.8 | 100 nm PMMA 1.0 | 50 nm silica 3.0 parts | 500 nm titanium dioxide 1.0 |
| example 74 | | parts by weight | by weight | parts by weight |
| | | 800 nm PTFE 2.0 | | |
| | | parts by weight | | |

Characteristic Analysis

To analyze physical properties of the toner core particles prepared in the Examples 1 to 64 and Comparative examples 1 to 74, tests were carried out as follows. For this purpose, image uniformity, image density, transfer property and long-term stability of the toner core particles were measured under printing conditions as described later by printing toner onto up to 500 paper sheets using a commercially available non-magnetic one-component developing printer (HP4600, Hewlett-Packard), which is provided in a contact developing device. The results are listed in the following Table 3.

1) Image Uniformity

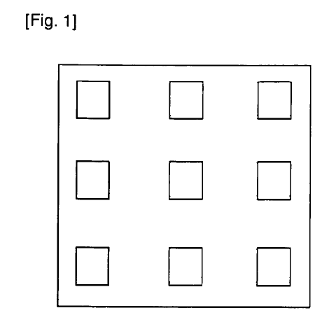

Image uniformity was determined by choosing 9 positions from a solid area image as shown in FIG. 1 and measuring image density in each of the 9 positions. The image uniformity is one of the important characteristics for maintaining an image for a long time, and therefore it is necessarily required to maintain uniform uniformity in the long-term printing.

The 9 positions in the solid area image were measured using the Macbeth densitometer RD918. The measured results were divided according to the following levels.

A: Difference in image density of an image is 0.1 or less

B: Difference in image density of an image is 0.3 or less

C: Difference in image density of an image is 0.8 or less

D: Difference in image density of an image is 1.2 or less

Image samples are taken by 1000 sheets per level, and up to 5000 sheets were measured for image density.

2) Image Contamination

Image contamination was measure on the basis of Primary Charge Roller (PCR) contamination.

A: PCR contamination is nearly not observed

B: PCR contamination is slightly observed

C: PCR contamination is plentifully observed

D: PCR contamination is too plentifully observed

3) Transfer Property

The percentage of toner purely transferred to the sheets was measured for the 5,000 printouts in every 500 sheets by calculating net consumption amount by subtracting loss from consumption amount.

A: transfer property of 80% or more

B: transfer property of 70 to 80%

C: transfer property of 60 to 70%

D: transfer property of 50 to 60%

4) Long Term Stability

It was determined whether image density (I.D) and transfer property are maintained by printing up to 5,000 sheets.

A: I.D. of 1.4 or more, transfer property of 75% or more in 5000 printouts

B: I.D. of 1.3 or more, transfer property of 70% or more in 5000 printouts

C: I.D. of 1.2 or less, transfer property of 60% or more in 5000 printouts

D: I.D. of 1.0 or less, transfer property of 40% or more in 5000 printouts

Differences in the physical properties were observed through the above-mentioned tests. The results are listed in the following Tables 3 and 4.

TABLE 3

| | Image | Image | | Long-term |
|---|---|---|---|---|
| | uniformity | contamination | Transfer property | stability |
| Example 1 | A | A | A | A |
| Example 2 | A | A | A | A |
| Example 3 | A | A | A | A |
| Example 4 | A | A | A | A |
| Example 5 | A | A | A | A |
| Example 6 | A | A | A | A |
| Example 7 | A | A | A | A |
| Example 8 | A | A | A | A |
| Example 9 | A | A | A | A |
| Example 10 | A | A | A | A |
| Example 11 | A | A | A | A |
| Example 12 | A | A | A | A |
| Example 13 | A | A | A | A |
| Example 14 | A | A | A | A |
| Example 15 | B | A | A | A |
| Example 16 | A | A | A | A |
| Example 17 | A | A | A | A |
| Example 18 | A | A | A | A |
| Example 19 | A | A | A | A |
| Example 20 | A | A | A | A |
| Example 21 | A | A | A | A |
| Example 22 | A | A | A | A |
| Example 23 | A | A | A | A |
| Example 24 | A | A | A | A |
| Example 25 | A | A | A | A |
| Example 26 | A | A | A | A |
| Example 27 | A | A | A | A |
| Example 28 | A | A | A | A |
| Example 29 | A | A | A | A |
| Example 30 | A | A | A | A |
| Example 31 | A | A | A | A |
| Example 32 | A | A | A | A |
| Example 33 | A | A | A | A |
| Example 34 | A | A | A | A |
| Example 35 | A | A | A | A |
| Example 36 | A | A | A | A |
| Example 37 | A | A | A | A |
| Example 38 | A | A | A | A |
| Example 39 | A | A | A | A |
| Example 40 | A | A | A | A |
| Example 41 | A | A | A | A |
| Example 42 | A | A | A | A |
| Example 43 | A | A | A | A |
| Example 44 | A | A | A | A |
| Example 45 | A | A | A | A |
| Example 46 | A | A | A | A |
| Example 47 | A | A | A | A |
| Example 48 | A | A | A | A |
| Example 49 | A | A | A | A |
| Example 50 | A | A | A | A |
| Example 52 | A | A | A | A |
| Example 53 | A | A | A | A |
| Example 54 | A | A | A | A |
| Example 55 | A | A | A | A |
| Example 56 | A | A | A | A |
| Example 57 | A | A | A | A |
| Example 58 | A | A | A | A |
| Example 59 | A | A | A | A |
| Example 60 | A | A | A | A |
| Example 61 | A | A | A | A |
| Example 62 | A | A | A | A |
| Example 63 | A | A | A | A |
| Example 64 | A | A | A | A |

TABLE 4

| | | | | Long- |
|---|---|---|---|---|
| | Image | Image | Transfer | term |
| | uniformity | contamination | property | stability |
| Comparative example 1 | D | D | D | D |
| Comparative example 2 | D | D | D | D |
| Comparative example 3 | D | D | D | D |
| Comparative example 4 | D | D | D | D |
| Comparative example 5 | D | D | D | D |
| Comparative example 6 | D | D | D | D |
| Comparative example 7 | D | D | D | D |
| Comparative example 8 | D | D | D | D |
| Comparative example 9 | D | C | D | D |
| Comparative example 10 | D | D | D | D |
| Comparative example 11 | D | D | D | D |
| Comparative example 12 | D | D | D | D |
| Comparative example 13 | D | D | D | D |
| Comparative example 14 | D | D | D | D |
| Comparative example 15 | D | D | D | D |
| Comparative example 16 | D | D | D | D |
| Comparative example 17 | D | D | D | D |
| Comparative example 18 | D | D | D | D |
| Comparative example 19 | D | D | D | D |
| Comparative example 20 | D | D | D | D |
| Comparative example 21 | D | D | D | D |
| Comparative example 22 | D | D | D | D |
| Comparative example 23 | D | D | D | D |
| Comparative example 24 | D | D | D | D |
| Comparative example 25 | D | D | D | D |
| Comparative example 26 | D | D | D | D |
| Comparative example 27 | D | D | D | D |
| Comparative example 28 | D | D | D | D |
| Comparative example 29 | D | D | D | D |
| Comparative example 30 | D | D | D | D |
| Comparative example 31 | D | D | D | D |
| Comparative example 32 | D | D | D | D |
| Comparative example 33 | D | D | D | D |
| Comparative example 34 | D | D | D | D |
| Comparative example 35 | D | D | D | D |
| Comparative example 36 | D | D | D | D |
| Comparative example 37 | D | D | D | D |
| Comparative example 38 | D | D | D | D |
| Comparative example 39 | D | D | D | D |
| Comparative example 40 | D | D | D | D |
| Comparative example 41 | D | D | D | D |
| Comparative example 42 | D | D | D | D |
| Comparative example 43 | D | D | D | D |
| Comparative example 44 | D | D | D | D |
| Comparative example 45 | D | D | D | D |
| Comparative example 46 | D | D | D | D |
| Comparative example 47 | D | D | D | D |
| Comparative example 47 | D | D | D | D |
| Comparative example 48 | D | D | D | D |
| Comparative example 49 | D | D | D | D |
| Comparative example 50 | D | D | D | D |
| Comparative example 51 | D | D | D | D |
| Comparative example 52 | D | D | D | D |
| Comparative example 53 | D | D | D | D |
| Comparative example 54 | D | D | D | D |
| Comparative example 55 | D | D | D | D |
| Comparative example 56 | D | D | D | D |
| Comparative example 57 | D | D | D | D |
| Comparative example 58 | D | D | D | D |
| Comparative example 59 | D | D | D | D |
| Comparative example 60 | D | D | D | D |
| Comparative example 61 | D | D | D | D |
| Comparative example 62 | D | D | D | D |
| Comparative example 63 | D | D | D | D |
| Comparative example 64 | D | D | D | D |
| Comparative example 65 | D | D | D | D |
| Comparative example 66 | D | D | D | D |
| Comparative example 67 | D | D | D | D |
| Comparative example 68 | D | D | D | D |
| Comparative example 69 | D | D | D | D |
| Comparative example 70 | D | D | D | D |
| Comparative example 71 | D | D | D | D |
| Comparative example 72 | D | D | D | D |
| Comparative example 73 | D | D | D | D |
| Comparative example 74 | D | D | D | D |

As listed the Tables 3 and 4, it was revealed that the toners of Examples 1-64, in which spherical organic powder, silica and titanium dioxide, all of which have different particle sizes, are used in the spheroidized toner core particles at the same time, are excellent in the aspects of image uniformity, image density, transfer property and long-term stability, compared to the toners of Comparative examples 1-74.

### INDUSTRIAL APPLICABILITY

As described above, the toner according to the present invention may be useful to modify surfaces of the toner core particles and improve charging characteristics using external additives, the toner core particles being able to maintain high chargeability and maintain charge uniformity and charge distribution to a sharp extent.

1. A toner having excellent image uniformity, comprising:
spheroidized toner core particles; and
an external additive coated onto surfaces of the toner core particles, wherein the external additive comprises organic powder, silica and spherical titanium dioxide powder having a spheroidization rate of 0.6 or more, represented by the following Equation 1:
Spheroidization rate=Circumference of a circle when being spherical/Circumference of particles. Equation 1

2. The toner of claim 1, wherein the spheroidized toner core particles have a spheroidization rate of 0.5 to 0.8 according to the Equation 1.

3. The toner of claim 2, wherein the spheroidization is carried out in one process selected from the group consisting of a process of spheroidizing toner particles using interfacial tension of the toner particles by spraying toner particles with thermal air current, and a process of grinding toner particles into a spherical shape by applying mechanical stress and frictional force to the toner particles.

4. The toner of claim 1, wherein the organic powder comprises large particles having an average particle size of 600 to 1000 nm and small particles having an average particle size of 50 to 120 nm.

5. The toner of claim 4, wherein the organic powder is selected from the group consisting of polytetrafluoroethylene (PTFE), polymethylmethacrylate (PMMA) and polyvinylidene fluoride (PVDF).

6. The toner of claim 4, wherein contents of the small particles and the large particles range from 0.4 to 1.0 part by weight and from 0.4 to 2.0 parts by weight, respectively, based on 100 parts by weight of the toner core particles.

7. The toner of claim 1, wherein the spherical titanium dioxide powder is composed of rutile-phase titanium dioxide.

8. The toner of claim 7, wherein the spherical titanium dioxide powder has an average particle size of 300 to 1000 nm.

9. The toner of claim 7, wherein a content of the spherical titanium dioxide powder ranges from 1.5 to 4 parts by weight, based on 100 parts by weight of the toner core particles.

10. The toner of claim 1, wherein the silica particles have a particle size of 5 to 20 nm.

11. The toner of claim 10, wherein a content of the silica particles ranges from 2 to 4 parts by weight, based on 100 parts by weight of the toner core particles.

12. The toner of claim 1, wherein the toner has a particle size of 10 μm or less.

13. The toner of claim 12, wherein the toner has a particle size of 3 to 9 μm.
